(19) United States
(12) Patent Application Publication
(10) Pub. No.: US 2007/0094596 A1
(43) Pub. Date: Apr. 26, 2007

(54) Glance modules

(76) Inventors: Per Nielsen, Chula Vista, CA (US); Kameron Kerger, San Diego, CA (US); Matt L. Davies, Cambridge (GB); Scott David Beith, Carlsbad, CA (US); Richard Peel, Stamford (GB)

Correspondence Address: QUALCOMM INCORPORATED, 5775 MOREHOUSE DR., SAN DIEGO, CA, 92121, US

(21) Appl. No.: 11/257,913

(22) Filed: Oct. 25, 2005

(51) Int. Cl. G06F 9/00

(52) U.S. Cl. 715/700

(57) ABSTRACT

A system is described to enable a user of a mobile device, such as a cellular telephone, to easily switch the display from a home screen, shown while the mobile device is idle, to a glance screen associated with a “glance module.” Multiple glance modules may be installed on the mobile device and the user may switch among them. Each glance module is associated with a different source of glanceable data.

### BACKGROUND

Mobile phone usage has become so popular that very many people think of their mobile phone as their number one accessory. Mobile phone usage is expected to grow even more as e-mail messaging and instant messaging become simpler and more pervasive on mobile devices. This widespread acceptance of mobile devices has not gone unnoticed by the technology community. Mobile phone developers are constantly improving the devices and adding new features and extensibility. What was at one time a simple device that did little more than allow a user to dial a phone number and have a conversation has evolved to a multifaceted communications device with real computing capability. Users can customize their mobile phones with various images and sounds, like new wallpaper and ringtones. Users can often add new functionality, like games or even more complex applications. The contemporary mobile device functions not only as a mobile telephone, but as a handheld communications and even computing device.

Service providers and other vendors are clamoring to capitalize on this improved functionality by offering enhanced services and products to mobile device users. For example, a service provider could offer a traffic update application that can be installed on a user's mobile device to keep the user apprised of current traffic conditions. Many service providers, perhaps in conjunction with outside vendors, offer applications that can be installed on a mobile device to retrieve the latest quotes for stocks the user is interested in. As mobile devices continue to evolve, the possibilities are limited only by the imaginations of the developers, users, and device manufacturers.

One problem with this development is that regardless of how powerful a mobile device becomes, it is still small. Users are simply resistant to large mobile devices, and understandably so. The larger a mobile device is, the less mobile it is. Technological advances are largely overcoming the size limitations in terms of storage capacity, bandwidth, and computing power. However, the laws of nature require that a small mobile device must have a small screen. This creates somewhat of a problem.

It is for this reason that service providers and vendors struggle with exactly what information to display on that screen and how. In other words, a screen having a given dimension can only display so much information in a usable way. This problem is exacerbated by the desire of many (if not most) users to personalize their user interface with images of family or the like.

Often a user or service provider may have installed several helpful applications or extra features. For instance, a user may have installed a “traffic conditions” application to determine traffic conditions just before, say, leaving work. However, the user may have some difficulty using the installed features because they are difficult to find. Ideally, the user would have one-touch access to everything available on the mobile device. However, that would require either the user remembering exactly what key-combination or trigger is associated with every single feature, or some hook into all those features would have to be displayed on the “home” screen. The “home” screen is a term commonly used to refer to the first screen that is displayed by the mobile device in an idle condition, such as when the mobile device first powers on. Obviously it is impractical to expect the user to remember a different key combination to activate every different feature on a mobile device. Accordingly, the preferred mechanism is to provide access to those features from the home screen. However, the small size of the display gives rise to competition between the several features for space on the home screen. In other words, when the service provider and/or equipment manufacturer configures the home screen layout, it must try to prioritize which of several different features or applications are accessible directly from a position on the home screen. Features that do not have a spot on the home screen must typically be accessed by navigating through a menu structure, which almost always involves several different, sometimes unintuitive key combinations.

In addition, users commonly like to personalize their home screen with things like images of their family members or icons of a favorite hobby. Users typically dislike their personalizations being obscured by feature icons or the like. So the user's desires can be at conflict with trying to maximize the number of features that are accessible directly from the home screen.

Accordingly, a superior mechanism and/or technique to access features on a mobile device has eluded those skilled in the art, until now.

### SUMMARY

The present invention is directed at a mechanism for enabling simple access to content on a mobile device. Briefly stated, a mobile device includes a display manager configured to display a home screen in an idle state, and a glance screen upon request. The home screen includes information deemed to be desirable for general display, and the glance screen includes more special-purpose information.

In one aspect, a system is envisioned including a computer-readable medium having computer-executable components that include a plurality of glance modules, each glance module being configured to create a glance screen including a first set of content, at least one of the glance modules being identified as a current glance module; and a display manager configured to display a home screen having a second set of content during an idle state, and to switch the display to the current glance module upon the occurrence of a glance trigger event.

In another aspect, a system is envisioned including a computer-implemented method, or a computer-readable medium having instructions that implement the method, for displaying information on a mobile device. The method includes receiving notice of a glance trigger event caused by activation of a glance trigger, the event being received by a display manager that has access to a plurality of plug-in glance modules, each glance module being configured to generate a different screen of information. The method further includes causing a current glance screen to be rendered and presented on a display of the mobile device, the current glance screen being under the control of a current glance module associated with some area of information and that defines a screen layout and content.

### BRIEF DESCRIPTION OF THE DRAWINGS

FIG. 1 is a graphical illustration of a mobile device having a home screen and being configured with “glance modules” as envisioned by embodiments of the present invention.

FIG. 2 is a conceptual illustration of two screens that may be displayed on a mobile device, such as the mobile device in FIG. 1, with a “home” screen having current focus, in accordance with one implementation of the present invention.

FIG. 3 is another view of the screens shown in FIG. 2 with the glance screen having the current focus.

FIG. 4 is a conceptual illustration of one implementation of the invention in which glance modules are accessible from a listing of installed glance modules.

FIG. 5 is another conceptual illustration of another implementation of the invention in which glance modules are serially accessible.

FIG. 6 is a functional block diagram of a mobile device having software components that embody one implementation of the invention.

FIG. 7 is a functional block diagram illustrating in greater detail certain of the software components shown in FIG. 5 that embody one implementation of the invention.

FIG. 8 is an operational flow diagram generally illustrating a process for accessing a feature installed on a mobile device in accordance with one implementation of the invention.

### DETAILED DESCRIPTION

Briefly stated, a glance module system is presented that enables a user of a mobile device, such as a cellular telephone, to easily switch the display from a home screen, shown while the mobile device is idle, to a glance screen associated with a “glance module.” Multiple glance modules may be installed on the mobile device and the user may switch among them. Each glance module is associated with a different resource or source of data. What follows is a detailed description of certain embodiments of this general concept.

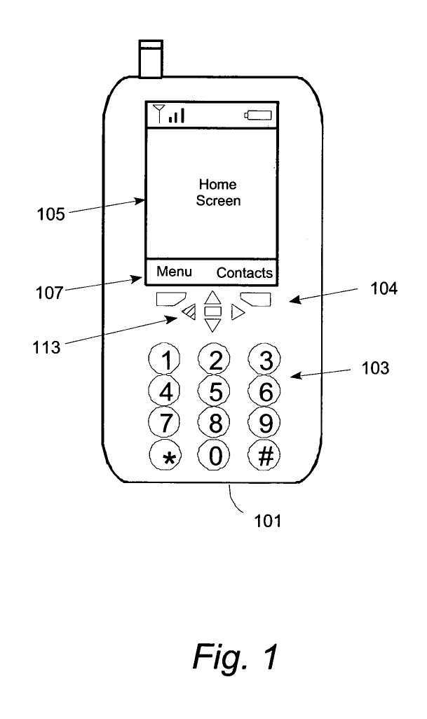

FIG. 1 is a graphical illustration of a sample mobile device 101 in which embodiments of the invention may be practiced. The mobile device 101 may be any telecommunications device used for wireless communications, such as a cellular telephone. Preferably, the mobile device 101 includes the capability for both voice and data communications.

A display panel 105 is used to provide a graphical display of information to the user. The display panel 105 commonly presents information such as the remaining battery life, the strength of the signal currently being received, and the like. The current state of any “soft keys” 107 may be shown on the display 105. The current state of the soft keys 107 (e.g., the actual text on the display 105) is context sensitive, meaning that the text being displayed may depend on the particular screen being displayed. As illustrated, in the context of the “home screen,” the soft keys 107 include a “menu” option and a “contacts” option.

The mobile device 101 may include several input devices. First, a keypad 103 includes buttons that may be used for dialing telephone numbers and perhaps keying data entries. The keypad 103 could be a conventional twelve-key keypad, a miniature QWERTY keypad, or the like.

Additional buttons 104 provide additional input capability. The additional buttons commonly include left and right “soft key” buttons, directional buttons (e.g., left, right, up, and down), and a selection button (often positioned in the center of the directional buttons). The “soft key” buttons are provided to activate any soft keys currently being displayed. For instance, as illustrated the mobile device 101 is currently displaying two soft key options 107, the “menu” option and the “contacts” option. Pressing the left soft key button triggers the “menu” option, while pressing the right soft key button triggers the “contacts” option. The functionality associated with each selection button changes as the soft key options (107) change.

In this embodiment, one of the additional buttons 104 (the left directional button 113 in this example) is used to swap the home screen for a “glance screen” associated with a glance module. Thus, the user is able to quickly glance at an additional screen of information, as defined by the currently assigned glance module, by simply activating the particular button associated with this feature. In other words, the alternative glance screen of information is simply one button away from the home screen. For the purpose of this discussion, the particular button or other input mechanism that is assigned to switch the display 105 from the home screen to the glance screen is generally termed the “glance trigger.”

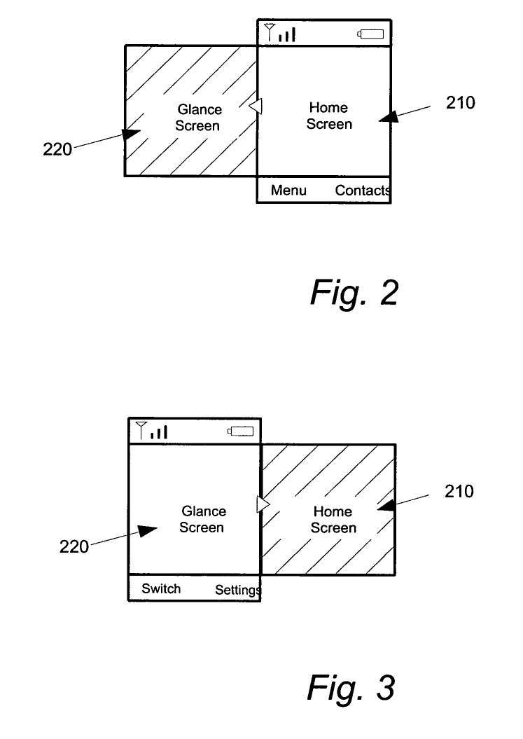

FIG. 2 is a conceptual illustration of two screens that may be displayed on a mobile device, such as the mobile device 101 in FIG. 1, with a “home” screen 210 having current focus, in accordance with one implementation of the present invention. More specifically, the home screen 210 is the first or default view presented, such as when the mobile device is initialized or becomes idle or dormant (referred to as the “idle state”). The home screen 210 includes information that perhaps the user, device manufacturer, or service provider has chosen to display while a mobile device is in the idle state, such as while the phone is not being used for a phone call or other operation. Commonly, the home screen 210 includes a link or other activation trigger to a menu to gain access to installed features on the mobile device. Often, the user will personalize the home screen 210, such as by installing images of interest to the user (e.g., family pictures, interesting avatars, and the like). During the idle state, the user can interact with any features or operations displayed on the home screen 210. When the user activates the “glance trigger” (e.g., the left directional button 113 in this example), the display changes to the glance screen 220, as shown in FIG. 3.

FIG. 3 is another view of the screens shown in FIG. 2 with the glance screen 220 having the current focus. As just mentioned, when the user activates the glance trigger, the current state changes from the idle state to the glance state, in which the mobile device displays the glance screen 220. In the glance state, the home screen 210 is not visible. Rather, a “glance module” (described more fully later) is activated and used to generate specialized display content for presentation on the glance screen 220. The glance screen 220 provides an easily-accessible alternative screen on which more specialized information or data can be presented.

At the expiration of a timeout period, or perhaps at the user's direction, the display returns to the idle state in which the home screen 210 is displayed on the mobile device, as shown in FIG. 2.

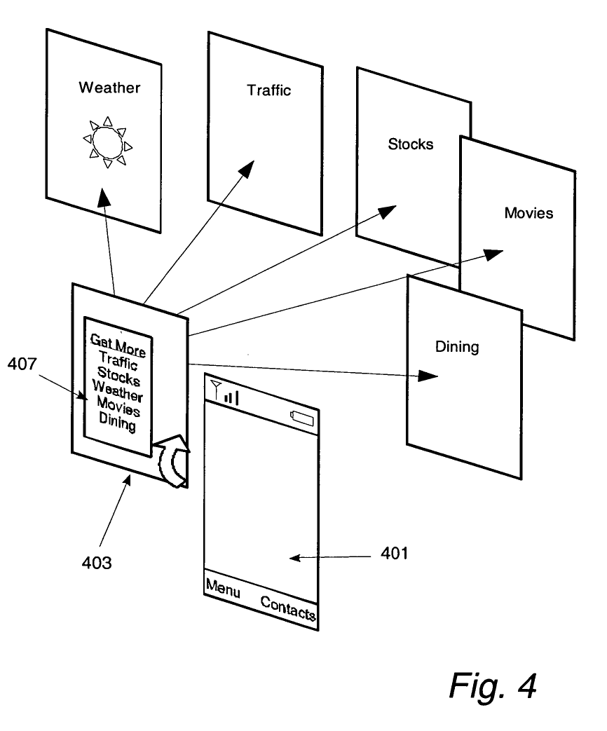

FIG. 4 is a conceptual illustration of one implementation of the invention in which glance modules are accessible from a listing of installed glance modules. In this implementation, a mobile device begins in an idle state with a home screen 401 being displayed. By activating a glance trigger as described above (e.g., pressing the left directional button), the display of the mobile device first switches to a current glance module 403.

The current glance module 403 could be a weather report or stock quote screen, for example. However, in some cases the current glance module 403 may not be the one that the user desires to see at the moment. So the user can change the current glance module 403 using a selection mechanism. In this implementation, the user changes the current glance module 403 by using a switch list 407. From the current glance module 403, the user presses a soft key associated with a switch list option 409 to bring up a switch list 407. The switch list 407 is a graphical representation of other installed glance modules, perhaps as a textual list or set of icons. The user scrolls up or down the switch list 407 to select the desired glance module. Selecting a particular entry on the switch list 407 causes the selected glance module to be displayed and set as the current glance module. Accordingly, when the user subsequently activates the glance trigger, the newly selected glance module will be immediately displayed.

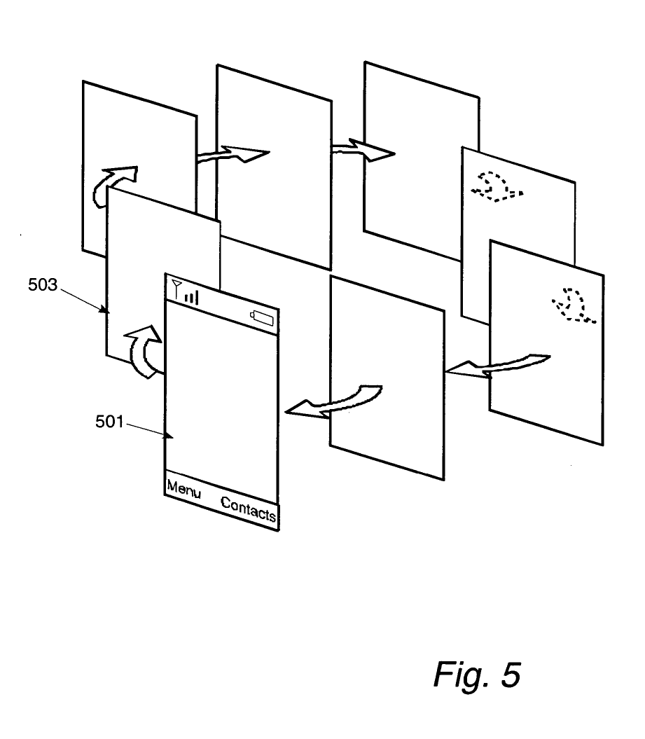

FIG. 5 is a conceptual illustration of another implementation of the invention in which glance modules are serially accessible. This alternative implementation provides a simpler mechanism for switching between glance modules than the mechanism described in conjunction with FIG. 4, although perhaps not as quick. More specifically, if the current glance module 503, meaning the one that is initially displayed when the glance trigger is first activated, is not the desired one, the user simply continues to activate the glance trigger until the desired glance module is presented. In other words, the display would serially cycle through each installed glance module with each activation of the glance trigger until the user stopped on one. When the user stops on a glance module, that one becomes the new current glance module. In one particular implementation, when the display reverts back to the home screen 501, an entry is stored indicating that the glance module that was last being displayed becomes the new current glance module. Thus, after the display reverts back to the home screen 501 and the user subsequently activates the glance trigger again, the newly selected glance module will be the first one displayed.

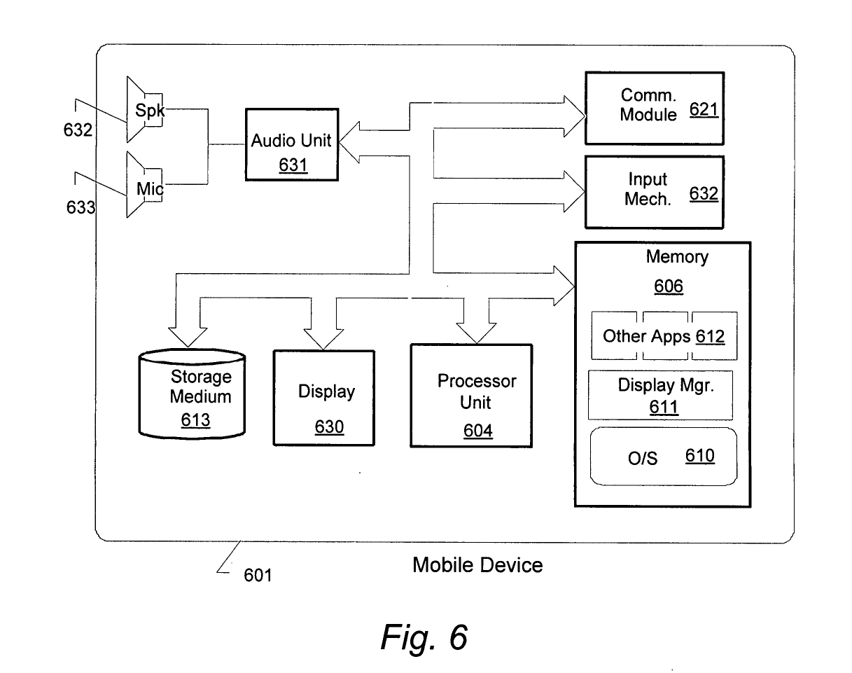

FIG. 6 is a functional block diagram of a sample mobile device 601 of the type that may be used in implementations of the invention. The mobile device 601 may be any handheld computing device and not just a cellular phone. For instance, the mobile device 601 could also be a mobile messaging device, a personal digital assistant, a portable music player, a global positioning satellite (GPS) device, or the like. Although described here in the context of a handheld mobile phone, it should be appreciated that implementations of the invention could have equal applicability in other areas, such as conventional wired telephone systems and the like.

In this example, the mobile device 601 includes a processor unit 604, a memory 606, a storage medium 613, an audio unit 631, an input mechanism 632, and a display 630. The processor unit 604 advantageously includes a microprocessor or a special-purpose processor such as a digital signal processor (DSP), but may in the alternative be any conventional form of processor, controller, microcontroller, state machine, or the like.

The processor unit 604 is coupled to the memory 606, which is advantageously implemented as RAM memory holding software instructions that are executed by the processor unit 604. In this embodiment, the software instructions stored in the memory 606 include a display manager 611, a runtime environment or operating system 610, and one or more other applications 612. The memory 606 may be on-board RAM, or the processor unit 604 and the memory 606 could collectively reside in an ASIC. In an alternate embodiment, the memory 606 could be composed of firmware or flash memory.

The display manager 611 is a utility or service that manages screens to be displayed on the mobile device. Described in greater detail below, the display manager 611 generally provides a home screen on the mobile device and a simple mechanism to allow a user to switch between the home screen and a glance screen.

The storage medium 613 may be implemented as any nonvolatile memory, such as ROM memory, flash memory, or a magnetic disk drive, just to name a few. The storage medium 613 could also be implemented as a combination of those or other technologies, such as a magnetic disk drive with cache (RAM) memory, or the like. In this particular embodiment, the storage medium 613 is used to store data during periods when the mobile device 601 is powered off or without power. The storage medium 613 could be used to store contact information, images, call announcements such as ringtones, and the like.

The mobile device 601 also includes a communications module 621 that enables bi-directional communication between the mobile device 601 and one or more other computing devices. The communications module 621 may include components to enable RF or other wireless communications, such as a cellular telephone network, Bluetooth connection, wireless local area network, or perhaps a wireless wide area network. Alternatively, the communications module 621 may include components to enable land line or hard wired network communications, such as an Ethernet connection, RJ-11 connection, universal serial bus connection, IEEE 1394 (Firewire) connection, or the like. These are intended as non-exhaustive lists and many other alternatives are possible.

The audio unit 631 is a component of the mobile device 601 that is configured to convert signals between analog and digital format. The audio unit 631 is used by the mobile device 601 to output sound using a speaker 632 and to receive input signals from a microphone 633. The speaker 632 could also be used to announce incoming calls.

A display 630 is used to output data or information in a graphical form. The display could be any form of display technology, such as LCD, LED, OLED, or the like. The input mechanism 632 may be any keypad-style input mechanism. Alternatively, the input mechanism 632 could be incorporated with the display 630, such as the case with a touch-sensitive display device. Other alternatives too numerous to mention are also possible.

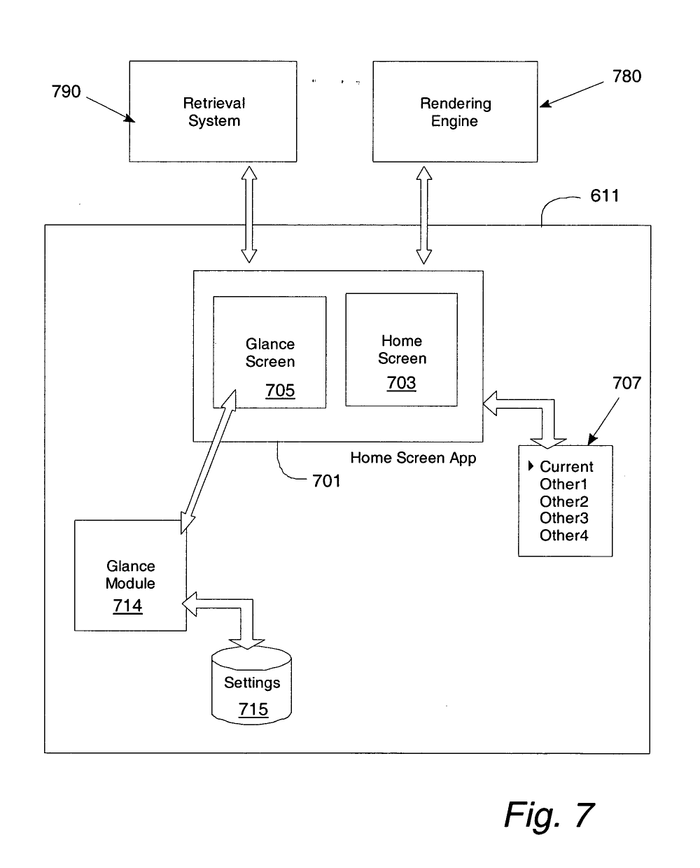

FIG. 7 is a functional block diagram illustrating in greater detail certain of the software components shown in FIG. 6 that embody one implementation of the invention. More specifically, FIG. 7 illustrates one implementation of the display manager 611 introduced above in conjunction with FIG. 6.

As illustrated in FIG. 7, the display manager 611 includes a home screen application 701, which is configured to switch a display between a home screen 703 and a glance screen 705 in response to the activation of a glance trigger. The home screen 703, as described above, includes information deemed appropriate for display during an idle state. In some cases, the home screen 703 includes information determined to be of a highest priority by either the mobile device manufacturer, the service provider, or perhaps the user. The information on the home screen 703 may tend to be more static in nature.

In this implementation, the home screen application 701 includes the capability to accept glance modules, such as glance module 714, that “plug in” to the home screen application 701. In other words, the home screen application 701 presents an execution environment in which a glance module 714, selected from a group of glance modules, can be launched.

Each glance module is a separate “applet” or small application constructed for runtime incorporation in the home screen application 701. Each glance module is configured to retrieve and present certain glanceable data. For the purpose of this discussion, the term “glanceable data” means information of an ephemeral, transient, or evanescent nature which is of interest to a user of the mobile device but which is likely to change rapidly. Examples of glanceable data are many, and include stock quotes, weather reports, traffic conditions, surf reports, ski reports, instant messaging communications, current status of the mobile device or installed features/applications on the mobile device, and the like. For example, if a mobile device includes an installed application for playing media files, such as MP3 files, a glance module could be configured to display the currently-playing song or playlist. In addition, a glance module could be configured in association with another application such that the glance module displays not only glanceable data, but also provides simple control of the associated application. Continuing with the media player example, a glance module could be configured to provide simple control (e.g., play, stop, pause, skip, etc.) over the associated application.

The home screen application 701 includes a module list 707 that identifies each glance module that is installed on the mobile device and registered with the home screen application 701. Additionally, at least one glance module is identified as a “current” glance module. The current glance module is the glance module that will be displayed initially when a glance trigger is activated. The home screen application 701 can change which glance module is current, such as by direct user input (e.g., a selection menu) or indirect input (e.g., making the last-viewed glance module the current one). An index or other identifier may be stored in association with the module list 707 to identify which glance module is the current one.

In one implementation, the glance module 714 includes code and/or instructions that define how the glance screen 705 will appear when rendered on a display. It is envisioned that glance modules may be constructed to present any of various types of information. Examples include weather reports, stock quotes, current traffic conditions, an e-mail inbox, an instant messaging interface, an image slideshow, the operational status of the mobile device, and the like. There is an endless number of types of glance modules that may be constructed and dynamically “plugged in” to the home screen application 701. The glance module 714 may additionally include configuration options that may be set by the user and stored in a configuration data store or file (e.g., settings 715).

It should be noted that the glance module 714 may be constructed to interact with other features or functionality of the host mobile device. In one common example, the glance module 714 may be configured to interact with a communications module to initiate a session with a remote device, such as an information server. Using this communications session, the glance module 714 can retrieve current information for inclusion in the glance screen 705. For example, if the glance module 714 is configured to display a current weather report, the glance module 714 may be configured to contact a remote weather site to retrieve the current weather conditions. The settings 715 may be used to store current geographic information that is used by the glance module 714 to retrieve the appropriate information. Alternatively, a Global Positioning System (GPS) component could be consulted to determine the current geographic location.

A rendering engine 780 may be used by the home screen application 701 to render the glance screen 705. The rendering engine 780 is configured to interpret instructions and/or code provided by other applications to produce a graphical image on a display screen. In implementations where the glance module 714 is a plug-in to the home screen application 701, the home screen application 701 may invoke the rendering engine 780 to render the code in the glance module 714, using the settings 715 if appropriate, to produce the glance screen 705. Alternatively, the glance module 714 may invoke the rendering engine 780 directly.

Additional glance modules could be downloaded or retrieved to the mobile device using a retrieval system 790. In one example, the retrieval system 790 could communicate with a remote application server and, when activated, present the user with a list of glance modules that may be retrieved to the mobile device. Retrieved glance modules may be stored on the mobile device and entered on the module list 707 so that they may be selected like the existing glance modules.

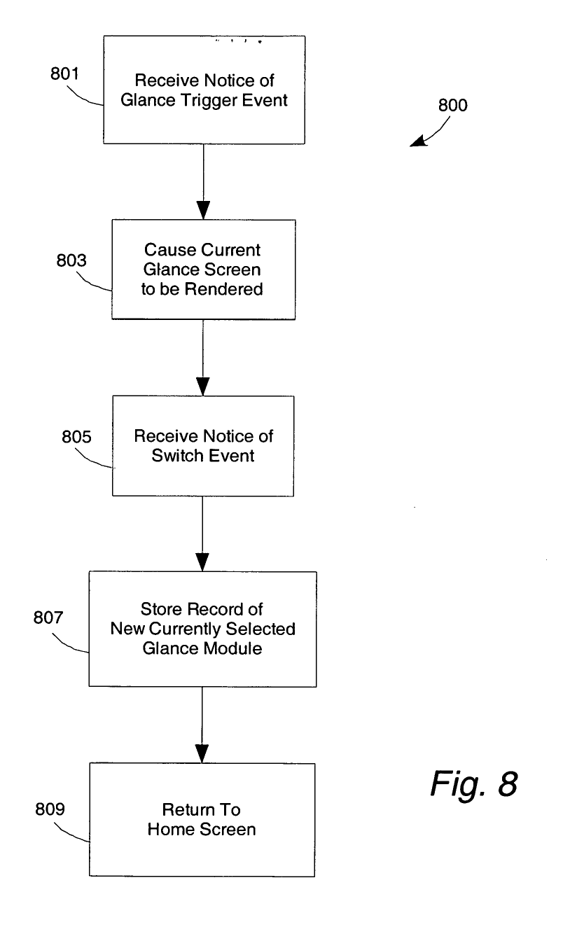

FIG. 8 is an operational flow diagram generally illustrating a process 800 for accessing a feature installed on a mobile device in accordance with one implementation of the invention. The process 800 is performed on a mobile device configured in accordance with one implementation of the invention. More specifically, the mobile device includes a display manager that has access to a plurality of glance modules with each glance module being configured to generate a different screen of information. The process 800 begins at step 801.

At step 801, the display manager receives notice of an event caused by the activation of a glance trigger. The glance trigger is an input mechanism, such as a directional button or the like, that is activated by a user to indicate a desire to change the display from its current state to a glance state.

At step 803, the display manager causes a current glance screen to be rendered and presented on the display of the mobile device. This step may include invoking a plug-in glance module that is associated with some area of information and which defines a screen layout and content. The content may be retrieved from remote data sources by the glance module. The display manager may consult or invoke a rendering engine in the performance of this step.

At step 805, optionally, the display manager may receive notice of a switch event that is operative to switch from the current glance module to a different glance module. The switch event may take many forms, such as an express indication that a switch of glance modules is desired, an implicit indication in the form of a subsequent glance trigger event. In other words, the switch event could be associated with the glance trigger input mechanism or with a different input mechanism.

At step 807, if a switch event has occurred, the display manager stores information that identifies which of the installed glance modules has been selected as the current glance module for use on subsequent occurrences of the glance trigger event.

At step 809, a return event occurs that causes the display manager to return the display screen from the glance screen to the home screen. The return event could be associate with a timeout period or an express input mechanism, such as a keypad button or the like.

While the present invention has been described with reference to particular embodiments and implementations, it should be understood that these are illustrative only, and that the scope of the invention is not limited to these embodiments. Many variations, modifications, additions and improvements to the embodiments described above are possible. It is contemplated that these variations, modifications, additions and improvements fall within the scope of the invention as detailed within the following claims.

I/We claim:

1. A computer-readable medium having computer-executable components, comprising:
a plurality of glance modules, each glance module being configured to create a glance screen including a first set of content, at least one of the glance modules being identified as a current glance module; and
a display manager configured to display a home screen during an idle state, the home screen having a second set of content, the display manager being further configured to switch the display to the glance screen of the current glance module upon the occurrence of a glance trigger event.

2. The computer-readable medium recited in claim 1, wherein at least one glance module is further configured to interact with another application stored in communication with the computer-readable medium, the glance module being configured to receive commands issued using the glance screen and to provide those commands to the other application.

3. The computer-readable medium recited in claim 1, wherein the plurality of glance modules includes at least a selected one of a group comprising a weather conditions applet, a traffic conditions applet, a stock quote applet, an instant messaging applet, a news reader applet, a media player applet, an image display applet, and a mobile device status applet.

4. The computer-readable medium recited in claim 1, wherein the display manager comprises a home screen application configured to receive plug in modules and each of the glance modules is configured to plug in to the home screen application.

5. The computer-readable medium recited in claim 1, wherein the display manager comprises a module list that identifies each of the plurality of glance modules.

6. The computer-readable medium recited in claim 5, wherein the module list further includes an identification of the current glance module.

7. The computer-readable medium recited in claim 1, wherein the display manager is further configured to receive notice to change the current glance module to another glance module.

8. The computer-readable medium recited in claim 7, wherein the notice to change the current glance module is received via a prompt with a listing of the plurality of glance modules.

9. The computer-implemented method recited in claim 1, wherein the first set of content comprises glanceable content.

10. A computer-implemented method for displaying information on a mobile device, the method comprising:
receiving notice of a glance trigger event caused by activation of a glance trigger, the event being received by a display manager that has access to a plurality of plug-in glance modules, each glance module being configured to generate a screen of information; and
causing a current glance screen to be rendered and presented on a display of the mobile device, the current glance screen being under the control of a current glance module associated with some area of information and that defines a screen layout and content.

11. The method recited in claim 10, wherein the display manager receives notice of a switch event that is operative to switch from the current glance module to a different glance module.

12. The method recited in claim 11, wherein the switch event comprises an express indication that a switch of glance modules is desired.

13. The method recited in claim 11, wherein the switch event comprises an implicit indication that a switch of glance modules is desired.

14. The method recited in claim 11, wherein the display manager stores information that identifies which of the installed glance modules has been selected as the current glance module for use on subsequent occurrences of the glance trigger event.

15. The method recited in claim 10, wherein a return event occurs that causes the display manager to return the display screen from the glance screen to a home screen.

16. The method recited in claim 15, wherein the return event occurs as a result of a timeout period or an express input.

17. The method recited in claim 10, wherein the glance trigger comprises an input mechanism that is activated to indicate a desire to change the display from its current state to a glance state.

18. The method recited in claim 17, wherein the input mechanism comprises a directional button.

19. The method recited in claim 10, wherein the content is retrieved from a remote data source by the glance module.

20. The method recited in claim 10, wherein the display manager invokes a rendering engine to render and/or present the glance screen.

21. The method recited in claim 10, wherein the content comprises glanceable content.

22. A computer-readable medium having computer-executable instructions for displaying information on a mobile device, the instructions comprising:
receiving notice of a glance trigger event caused by activation of a glance trigger, the event being received by a display manager that has access to a plurality of plug-in glance modules, each glance module being configured to generate a screen of information; and
causing a current glance screen to be rendered and presented on a display of the mobile device, the current glance screen being under the control of a current glance module associated with some area of information and that defines a screen layout and content.

23. A mobile device, comprising:
a display component;
a processor for executing software components; and
a memory in which to execute the software components, the software components comprising:
a plurality of glance modules, each glance module being configured to create a glance screen including a first set of content, at least one of the glance modules being identified as a current glance module; and
a display manager configured to display a home screen having a second set of content during an idle state, and to switch the display to the glance screen of the current glance module upon the occurrence of a glance trigger event.

24. The mobile device recited in claim 23, wherein at least one glance module is further configured to interact with another application stored in communication with the computer-readable medium, the glance module being configured to receive commands issued using the glance screen and to provide those commands to the other application.

25. The mobile device recited in claim 23, wherein the plurality of glance modules includes at least a selected one of a group comprising a weather conditions applet, a traffic conditions applet, a stock quote applet, an instant messaging applet, a news reader applet, a media player applet, an image display applet, and a mobile device status applet.

26. The mobile device recited in claim 23, wherein the display manager comprises a home screen application configured to receive plug in modules and each of the glance modules is configured to plug in to the home screen application.

27. The mobile device recited in claim 23, wherein the display manager comprises a module list that identifies each of the plurality of glance modules.

28. The mobile device recited in claim 27, wherein the module list further includes an identification of the current glance module.

29. The mobile device recited in claim 23, wherein the display manager is further configured to receive notice to change the current glance module to another glance module.

30. The mobile device recited in claim 29, wherein the notice to change the current glance module is received via a prompt with a listing of the plurality of glance modules.

31. The mobile device recited in claim 23, wherein the first set of content comprises glanceable content.

32. A mobile device, comprising:
means for receiving notice of a glance trigger event caused by activation of a glance trigger, the event being received by a display manager that has access to a plurality of plug-in glance modules, each glance module being configured to generate a different screen of information; and
means for causing a current glance screen to be rendered and presented on a display of the mobile device, the current glance screen being under the control of a current glance module associated with some area of information and that defines a screen layout and content.
